(19) United States
(12) Patent Application Publication
(10) Pub. No.: US 2017/0000042 A1
(43) Pub. Date: Jan. 5, 2017

(54) LANDSCAPING AND GARDENING APPARATUS AND METHOD

(71) Applicant: Jim Gilchrist, Brampton (CA)

(72) Inventor: Jim Gilchrist, Brampton (CA)

(21) Appl. No.: 14/788,978

(22) Filed: Jul. 1, 2015

(51) Int. Cl. A01G 9/02

(52) U.S. Cl. CPC A01G 9/02

(57) ABSTRACT

An apparatus for landscaping is disclosed having a casing of flexible fluid-permeable material for retaining a plant-growing medium preformed into a toroid-shape, having an inner radius, r, r>0, and an outer radius, R, R>r.

### FIELD OF INVENTION

The present invention relates to gardening, in particular an apparatus and method for landscaping.

### BACKGROUND

Landscaping and planting a traditional garden are both time consuming and labor intensive. Removing sod, digging earth, removing rocks, laying anti-weed fabric, distributing and planting bulbs, seeds or plugs, is difficult for the average person not accustomed to this type of physical activity. Furthermore, designing and implementing the shape of a garden and selecting plants and flowers that complement each other to produce an esthetically pleasing garden, is also difficult for amateur gardeners. Non-traditional garden systems that require less work, time and space, have been developed for those who have little outdoor space, do not have the time and or skills required to plan and plant a garden. There are currently some products that help reduce the labor required but do not necessarily aid amateur gardeners create artistic and visually appealing gardens.

Most homeowners desire beautifully landscaped gardens, however, do not have the resources to hire professional landscapers, nor do they have the time, energy or knowledge to landscape their yards as they wish.

It would be advantageous to overcome some of the disadvantages of the prior art.

### SUMMARY OF THE EMBODIMENTS OF THE INVENTION

In accordance with the invention there is provided an apparatus for landscaping comprising a first casing of flexible fluid-permeable material of toroid-shape, having an inner radius, r, r>0, and an outer radius, R, R>r, for retaining a plant-growing medium within the first casing.

In accordance with the invention there is provided another apparatus landscaping comprising an enclosed first casing of flexible fluid-permeable material having an opening for inserting a plant-growing medium into the enclosed first casing; and a fastening device for closing the opening for retaining the plant-growing medium within the first casing.

In accordance with the invention there is provided a method for landscaping comprising providing a first casing of flexible fluid-permeable material of toroid-shape and inserting a plant-growing medium within the first casing.

In accordance with the invention there is provided a kit for landscaping comprising a casing of flexible fluid-permeable material of toroid-shape, having an inner radius, r, r>0, and an outer radius, R, R>r, for retaining a plant-growing medium within the first casing and at least one of the plant-growing medium, a drainage medium for drainage of fluid from the plant-growing medium and plant material.

### BRIEF DESCRIPTION OF THE DRAWINGS

Exemplary embodiments will now be described in conjunction with the following drawings, wherein like numerals refer to elements having similar function, in which:

FIG. 1 is a simplified diagram of prior art.

FIG. 2A is a simplified top view of a casing for holding a plant-growing medium according to an embodiment of the invention.

FIG. 2B is a simplified top view of a casing for holding a plant-growing medium according to an embodiment of the invention shown with ends separated.

FIG. 2C is a simplified top view of a casing for holding a plant-growing medium according to an embodiment of the invention showing a fastener detachably coupling overlapping portions of the casing together.

FIG. 2D is a simplified profile view of a casing for holding a plant-growing medium according to an embodiment of the invention showing a fastener detachably coupling overlapping portions of the casing together.

FIG. 3A is a simplified top view of a casing for holding a plant-growing medium according to an embodiment of the invention.

FIG. 3B is a simplified cross-sectional view of an empty casing for holding a plant-growing medium.

FIG. 3C is a simplified cross-sectional view of a casing filled with a plant-growing medium wherein the shape of cross-sections of ends of the casing are the same as cross-sections of other portions of the casing.

FIG. 3D is a simplified cross-sectional view of a casing filed with a plant-growing medium wherein the shape of cross-sections of ends of the casing are not the same as cross-sections of other portions of the casing.

FIG. 3E is a simplified diagram of a casing comprising an opening for insertion of a plan-growing medium and to prevent the plant-growing medium from escaping the casing.

FIG. 3F is a simplified top view of a casing comprising a fastening device and a coupling mechanism according to an embodiment of the invention.

FIG. 4A is a simplified profile view of a casing filled with a plant-growing medium placed around a tree trunk.

FIG. 4B is a simplified top view of a casing filled with a plant-growing medium placed around a tree trunk.

FIG. 5A is a simplified top view of a casing filled with a plant-growing medium and having punctured therein.

FIG. 5B is a simplified profile view of a casing filled with a plant-growing medium and having punctured holes therein.

FIG. 5C is a simplified top view of a casing filled with a plant-growing medium having flowers growing therefrom.

FIG. 5D is a simplified profile view of a casing filled with a plant-growing medium having flowers growing therefrom.

FIG. 5E is a simplified profile view of a casing positioned around the trunk of a tree and covered in flowers growing therefrom.

FIG. 6A is a simplified top view of a casing filled with an expandable plant-growing medium according to an embodiment of the invention.

FIG. 6B is a simplified cross-sectional view of a casing filled with a plant-growing medium comprising dry expandable plant-growing material.

FIG. 6C is a simplified cross-sectional view of a casing filled with a plant-growing medium comprising wet expandable plant-growing material.

FIG. 7A is a simplified top view of a casing filled with a plant-growing medium and comprising a drainage medium.

FIG. 7B is a simplified cross-section view of a casing filled with a plant-growing medium and comprising a drainage medium.

FIG. 7C is a simplified cross-section view of a casing filled with a plant-growing medium and comprising a drainage medium and a coupling mechanism.

FIG. 8 shows simplified casings according to an embodiment of the invention.

FIG. 9 shows simplified top and profile views of exemplary embodiments of enclosed casings according to the invention.

FIG. 10 shows simplified diagrams of a plurality of casings detachably coupled one to another.

### DETAILED DESCRIPTION OF THE EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

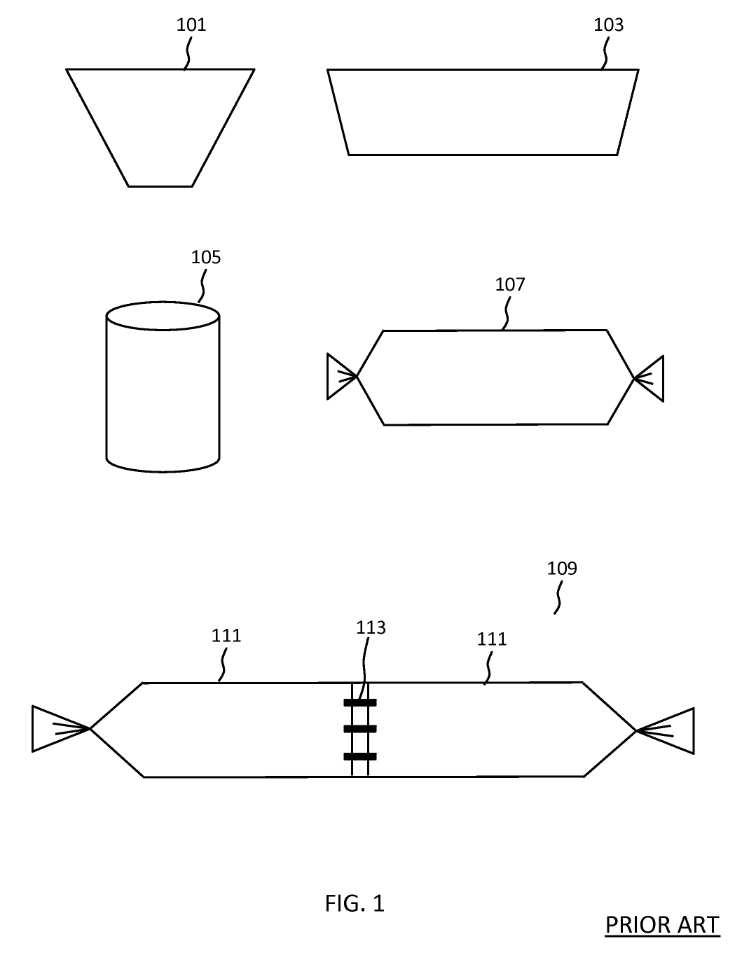

Shown in FIG. 1 are vessels and containers currently used in traditional gardens, as well as in areas where plants are desired yet there no soil available. For example, patios, pool decks, windowsills, rocks, fences, trellises, and inside a home. Flowerpots and planters, for example 101 and 103, are traditional plant containers that are used both inside and outside a home for containing, for example, decorative plants, flowers, and herbs. Grow bags, such as, grow bag 105, have become popular among urban gardeners that either have no yard, such as people living in apartment-type homes, or those who do not wish to plant a traditional garden. A user fills a grow bag with a plant-growing medium (not shown), punctures holes in the sides of the grow bag, then plants bulbs, seeds or plugs via the punctured holes and/or the bag opening on top. Typically, grow bags are taller than they are wide, minimizing the horizontal space needed to grow plants.

Still referring to FIG. 1, empty tubular mesh, 107 and 109, for example tubular mesh sold under the trademark GardenSoxx™, is purchased by a user. The user cuts the empty tubular mesh to a desired length, fills the tubular mesh with a plant-growing medium (not shown), and ties each end of the tubular mesh to keep the plant-growing medium within the tubular mesh. Next, the user punctures holes in the tubular mesh and plants bulbs, seeds or plugs via the punctured holes. A user can secure various lengths of the tubular mesh, for example, portions 111, together using cable ties 113 to produce long straight tubes. Should a user wish to use tubular mesh to create a flowerbed that is not in a straight line, a user will have to manipulate and secure a straight tube into the desired shape. For example, if a user desires a circular flower bed, the user will have to manipulate the straight tube into a circular shape, secure the tube, for example with cable ties, so that the tube maintains a circular shape. The user will also have to secure the two ends of the tube together to create a visually continuous circular flowerbed.

Definition: A “toroid” is a geometric surface or enclosed solid which shape and structure is generated by a closed curve rotating about a straight line (e.g. axis) in its own plane. A torus is a particular form of a toroid in which the closed curve is a circle. A doughnut is an example of a torus.

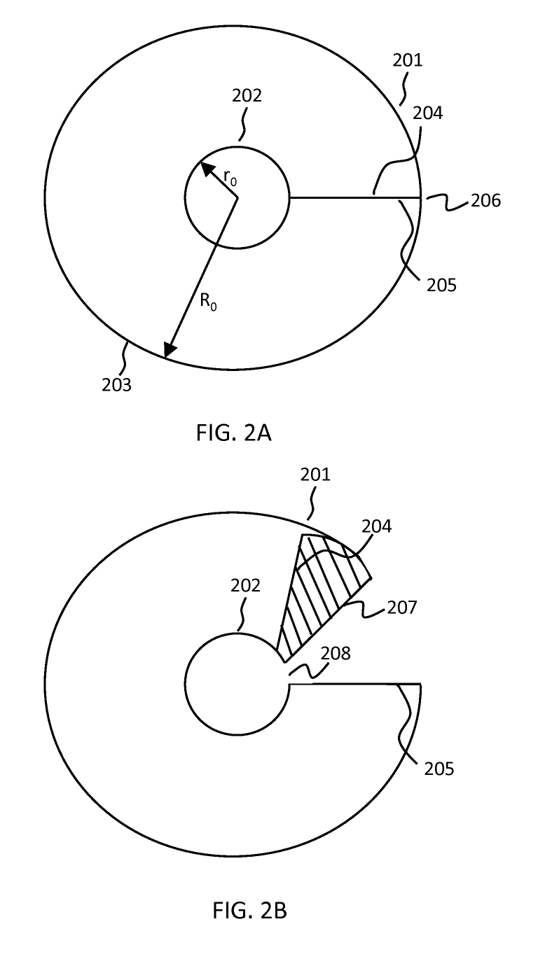

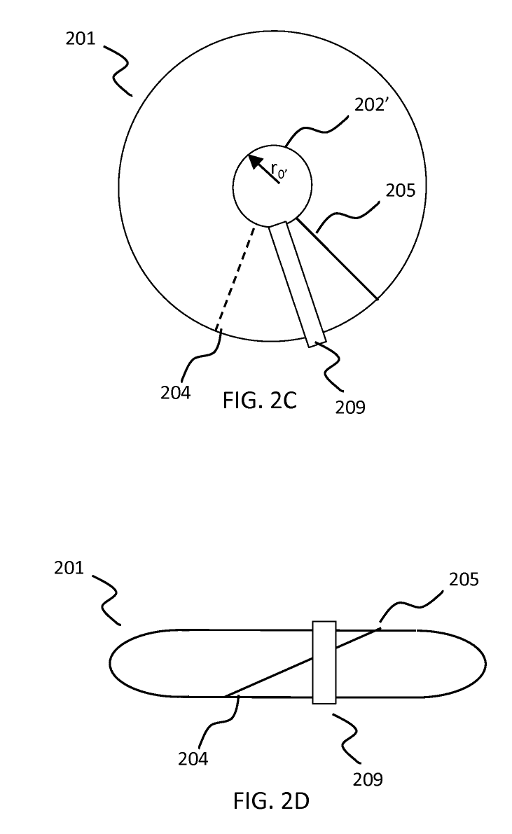

According to an embodiment of the invention, a casing for retaining a plant-growing medium is preformed/manufactured into a toroid-shape, as shown in simplified top views in FIG. 2A and FIG. 2B of casing 201. Casing 201 comprises a flexible fluid-permeable material, having an inner ring 202 of radius r, r>0 and a larger outside ring 203 of radius R, where R>r. In this example, r=r₀ and R=R₀. Casing 201 is not continuous and comprises two ends, 204 and 205, adjacent each other at location 206. A plant-growing medium (not shown), for example, topsoil, is inserted into casing 201 via an opening (not shown), providing access to inside casing 201. Optionally, casing 201 comprises a weed-deterring material, for example, a material similar to weed-control fabric used in traditional gardens. Alternatively, casing 201 is continuous.

Referring now to FIG. 2B, shown is casing 201 wherein ends 204 and 205 are no longer adjacent, but separated, one from the other. As casing 201 is flexible, a portion 207 of casing 201 is folded back, as shown, to provide access to inner ring 202 via opening 208 created when portion 207 was folded back. Casing 201 is placed around an object, for example, a tree trunk, such that inner ring 202 encircles the tree trunk. Portion 207 is returned to it's original position as shown in FIG. 2A. In this embodiment, casing 201 is in a torus shape, however, casing 201 can be of any toroid-shape, a specific and non-limiting example is an elliptical toroid.

Shown in FIG. 2C is a simplified top view of a casing, comprising a detachable fastener, according to an embodiment of the invention. Detachable fastener 209 is for securing over lapping portions of casing 201 together. A user wishes to place casing 201 around a sapling, however the radius of inner ring 202 is much larger than then radius of the sapling trunk. The user desires flowers growing out of casing 201 to be proximate the sapling trunk. The user overlaps portions of casing 201 proximate ends 204 and 205 to reduce the inner ring radius of casing 201, r₀ to r_{0′}, where r₀>r_{0′}, such that inner ring 202′ is proximate the sapling trunk. FIG. 2D is a simplified profile view of casing 201 showing fastener 209 detachably coupling overlapping portions thereof.

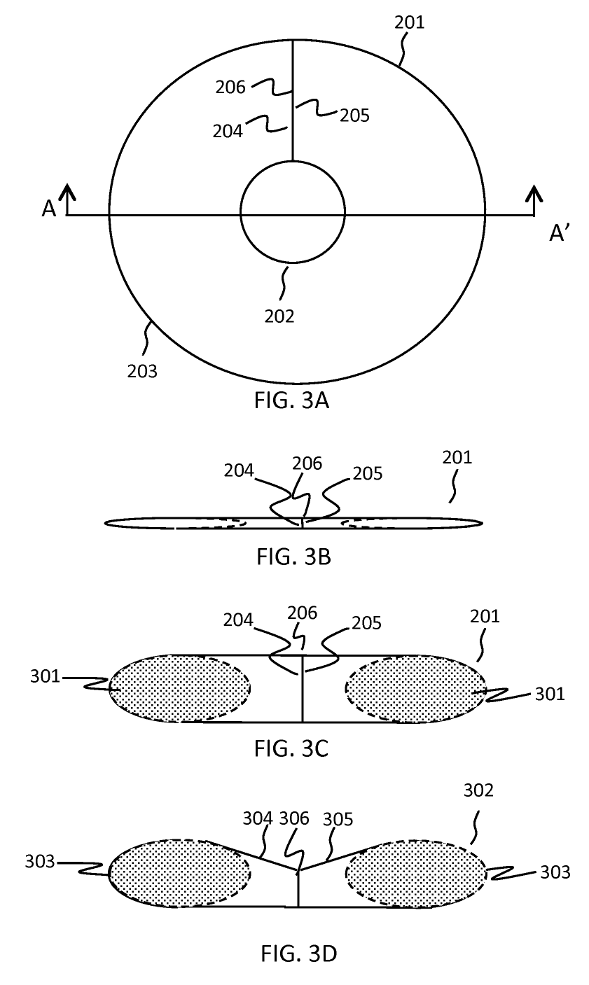

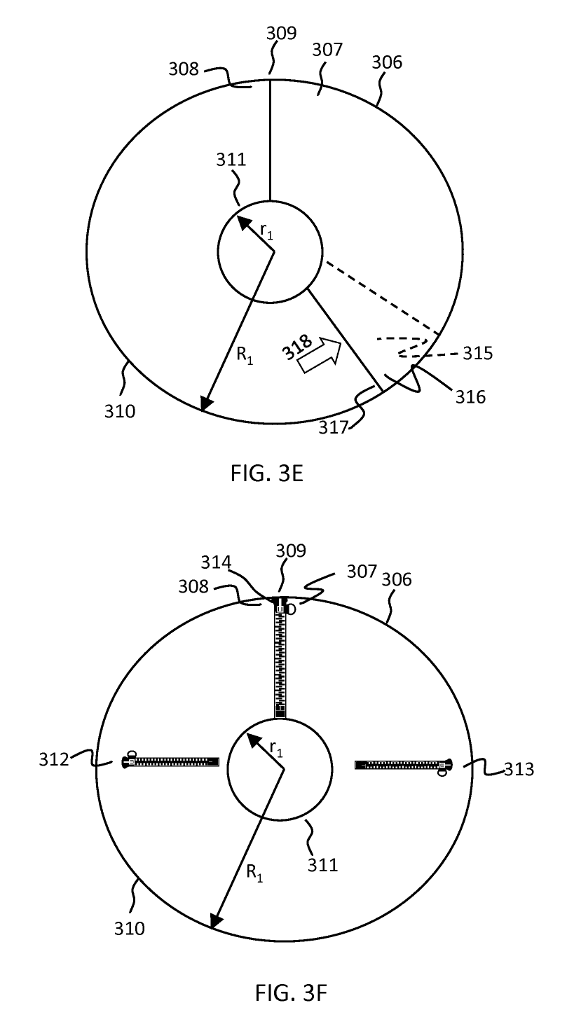

Shown in FIG. 3A is another simplified top view of casing 201. FIG. 3B is a simplified cross-sectional view at line A-A′ of empty casing 201, in other words, casing 201 is not filled with a plant-growing medium. FIG. 3C is a second simplified cross-sectional view at line A-A′ of casing 201, filled with a plant-growing medium 301, for example, Sphagnum Moss. Other specific and non-limiting examples of plant-growing mediums include potting soil, soilless potting mix and a garden soil sold under the trademark Miracle-Gro™. As shown in FIG. 3C, ends 204 and 205 are the same cross-sectional area as all other portions of casing 201. Alternatively, shown in FIG. 3D, is a simplified cross-sectional view of casing 302, wherein ends 304 and 305 of casing 302 are not the same cross-sectional area of other portions thereof. Ends 304 and 305 are tapered to meet at location 320. In this example, cross-sections of casing 201 and casing 302 are elliptical in shape. Alternatively, the shape of cross-sections of casing 201 and casing 302 are not elliptical in shape. Alternatively, the shape of cross-sections of casing 201 and casing 302 are one of circular, rectangular and square.

Shown in FIG. 3E is a simplified top view of another embodiment according to the invention. Casing 306 for retaining a plant-growing medium is preformed/manufactured into a toroid-shape. Casing 306 comprises a flexible fluid-permeable material having an inner ring 311 of radius r, r>0 and a larger outside ring 310 of radius R, where R>r. In this example, r=r₁ and R=R₁. Casing 306 is not continuous and comprises two ends, 308 and 307, adjacent one to the other at location 309. A plant-growing medium (not shown), for example, topsoil, is inserted into casing 306 via an opening in casing 306. In this example, portion 316 of casing 306 overlaps portion 315 of casing 306 and is not coupled thereto. Opening 317 between portions 315 and 316 is where the plant-growing medium is inserted into casing 306 as indicated by arrow 318. Overlapping portion 316, although not coupled to portion 315, deters the plant-growing medium from spilling out of casing 306. Optionally, casing 306 has more than one opening. Optionally, casing 306 comprises a weed-deterring material, for example, a material similar to weed control fabric used in traditional gardens.

Alternatively, as shown in FIG. 3F, an opening is created in casing 306 when a fastening device 312, such as a zipper, is open. When closed, fastening device 312 prevents the plant-growing medium from escaping casing 306. In this example, fastening device 312 is integrated into casing 306. Alternatively, the fastening device comprises fastening tape. Alternatively, the fastening device comprises a fastening tape sold under the trademark Velcro′ consisting of opposing pieces of fabric, one with a dense arrangement of tiny nylon hooks and the other with a dense nylon pile, that interlock when pressed together, used as a closure. Alternatively, another fastening device is used. Optionally, the fastening device is not integrated into casing 306.

Optionally, casing 306 has more than one fastening device, such as second fastening device 313, for example a zipper. When second fastening device 313 is open, a plant-growing medium is inserted inside casing 306 via second fastening device 313. When closed, second fastening device 313 prevents the plant-growing medium from escaping casing 306. In this example, second fastening device 313 is integrated into casing 306. Alternatively, the second fastening device comprises fastening tape. Alternatively, the second fastening device comprises a fastening tape sold under the trademark Velcro′ consisting of opposing pieces of fabric, one with a dense arrangement of tiny nylon hooks and the other with a dense nylon pile, that interlock when pressed together, used as a closure. Alternatively, another fastening device is used. Optionally, the second fastening device is not integrated into casing 306.

Optionally, ends 308 and 307 are detachably coupled to form a continuous toroid-shape. For example, ends 308 and 307 are detachably coupled with a coupling mechanism 314 at location 309, for example a zipper. In this example, coupling mechanism 314 is integrated into casing 306. Alternatively, the coupling mechanism comprises fastening tape. Alternatively, the coupling mechanism comprises a fastening tape sold under the trademark Velcro™ consisting of opposing pieces of fabric, one with a dense arrangement of tiny nylon hooks and the other with a dense nylon pile, that interlock when pressed together, used as a closure. Alternatively, another coupling mechanism is used. Optionally, the coupling mechanism is not integrated into casing 306.

Coupling mechanism 314 also enables the user to easily remove casing 306, along with any plants that are planted therein, from around an object, for example a tree trunk. For example, if an Ash tree that casing 306 encircles is destroyed by pests, such as the Emerald Ash Borer, the user will remove casing 306 encircling the dying Ash tree, remove the Ash tree, replace it with a different tree, such as a Maple tree, and reposition casing 306 such that it encircles the newly planted Maple tree. Coupling mechanism 314 secures ends 308 and 307 together to create a continuous toroid-shape and provides the user a means to relocate casing 306 if required. The reader will appreciate that if the flowers had been planted in the ground instead of in casing 306, the flowers would have been destroyed when the Ash tree was removed.

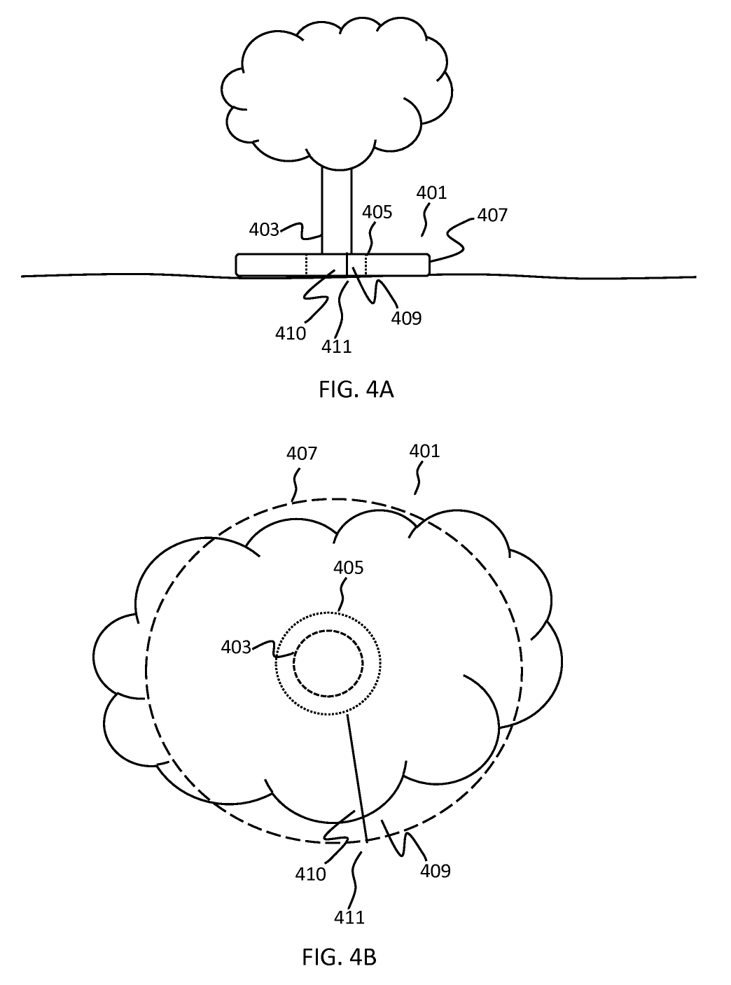

Shown in FIG. 4A is a simplified profile view of an embodiment of the invention wherein casing 401, similar to casing 201, is placed around tree trunk 403. Casing 401 comprises a flexible fluid-permeable material for retaining a plant-growing medium (not shown) therein, and is preformed/manufactured into a toroid-shape, having an inner ring 405 and an outer ring 407. Casing 401 also comprises a first end 409 and second end 410 adjacent thereto. In this embodiment, casing 401 is a torus-shape; however, casing 401 can be of any toroid-shape, a specific and non-limiting example is an elliptical toroid. FIG. 4B is a simplified top view of casing 407 wrapped around tree trunk 403. A casing is pre-formable into various shapes and sizes, wherein the casing inner ring, outer ring, cross-section shape and area, shape of ends and material is varied. Optionally, casing 401 comprises a weed-deterring material, for example, a material similar to weed control fabric used in traditional gardens.

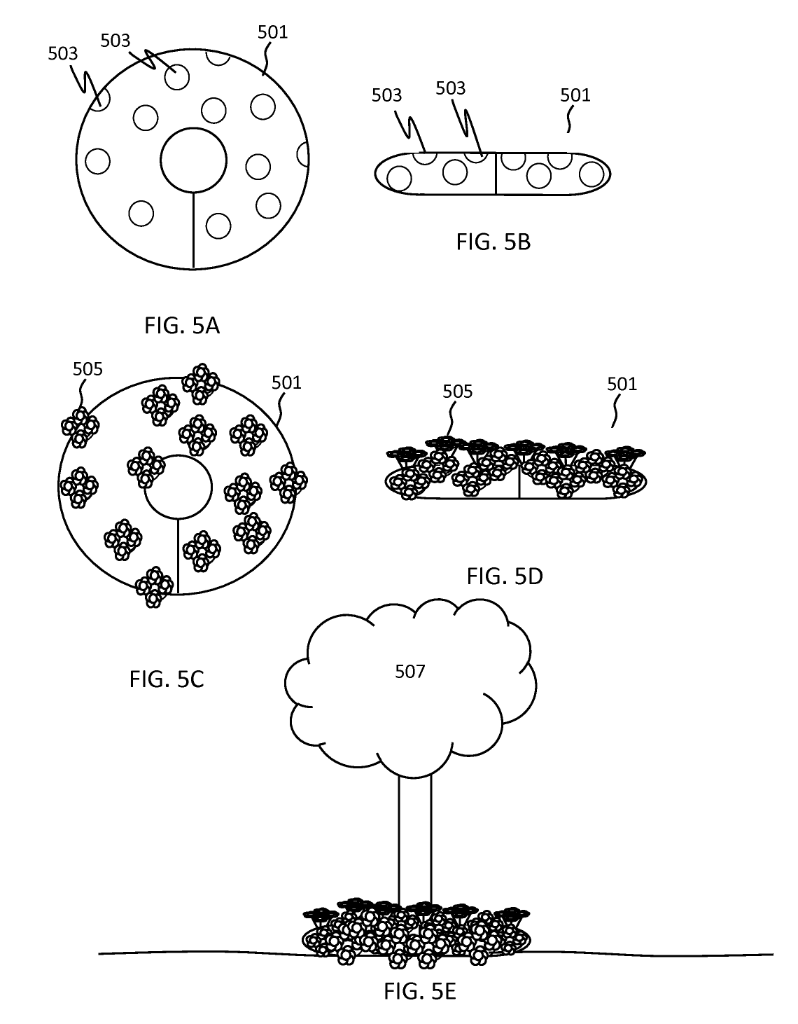

Now referring to FIG. 5A and FIG. 5B, shown are simplified top and profile views of casing 501, respectively, according to an embodiment of the invention. A user purchases casing 501 for retaining a plant-growing medium preformed/manufactured into a toroid-shape comprising a flexible fluid-permeable material. Casing 501, when purchased, is prefilled with a plant-growing medium. Alternatively, casing 501 is empty and the user fills casing 501 with a plant-growing medium. The user punctures holes 503 in casing 501 and plants plant material, such as flower bulbs into the plant-growing medium via punctured holes 503. Alternatively, the plant material is seed. Alternatively, the plant material comprises plugs. Casing 501 is watered; the water passes through the flexible liquid-permeable material of casing 501. Alternatively, casing 501 is watered prior to puncturing holes. Over time, flowers 505 grow out of casing 501, as shown in FIG. 5C and FIG. 5D, simplified top and profile views of casing 501, respectively. As more time passes, flowers 505 grow to cover casing 501. FIG. 5E is a simplified profile view of casing 501 positioned around the trunk of tree 507 and covered in flowers 505. A ring of flowers around a tree is esthetically pleasing, and by using a casing such as casing 501 to create such a landscape, a user avoids much of the traditional work associated with planning and planting a garden. Optionally, plant material such as seeds and/or bulbs are pre-planted in the plant-growing medium prior to the user purchasing casing 501. Optionally, markings on the casing exterior indicate to the user where holes are to be created. Optionally, the casing comprises one or more portions having score lines, making it easier for the user to remove the portions of casing 501 to create holes. Alternatively, a casing is sold with a plant-growing material comprising plant material such as plugs and the user need only place the casing in a desired location and then water the casing encouraging the existing plants to grow.

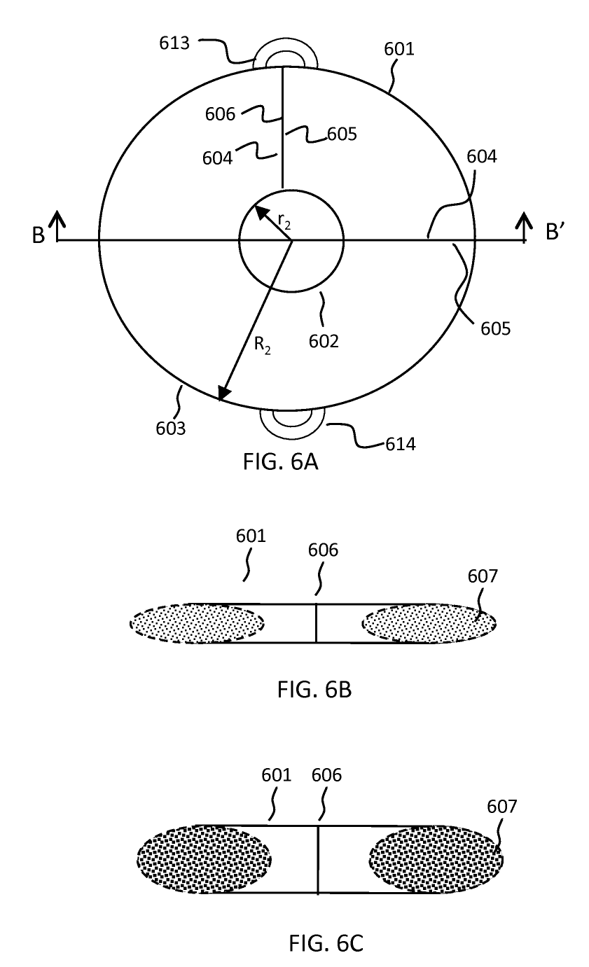

According to another embodiment of the invention, a casing for a retaining plant-growing medium, is preformed/manufactured into a toroid-shape, and comprises a flexible fluid-permeable material. A specific and non-limiting example of a flexible fluid-permeable material is sold under the trademark Plantex™. For example, shown in FIG. 6A is a simplified top view of casing 601 having an inner ring 602 of radius r, r>0 and a larger outside ring 603 of radius R, where R>r. In this example, r=r₂ and R=R₂. Casing 601 is not continuous, and comprises two ends, 604 and 605 which are adjacent one another and meet at location 606, as shown in simplified view FIG. 6A. Casing 601 is filled with an expandable plant-growing medium 607, a specific and non-limiting example of an expandable plant-growing medium is sold under the trademark Wonder Soil™. Shown in FIG. 6B is a simplified cross-sectional view taken at line B-B′ of casing 602 purchased by a user. A usual characteristic of an expandable plant-growing medium is that it is light in comparison to regular soil or other plant-growing mediums used in gardening. As such, a vendor may sell a product similar to casing 601 prefilled with expandable plant-growing medium online, as shipping costs would not significantly increase the cost of the product. Alternatively, casing 601 is purchasable in gardening, grocery and department stores as it would be light enough for a customer to carry to their car and then to their home. The user places casing 601 in a desired location, some specific and non-limiting examples include, around a tree, lamppost, an existing plant that is small enough to fit within inner ring 602, on a patio, pool deck and in a rock garden. Once casing 601 is in the desired location the user waters casing 601 and upon the expandable plant-growing medium getting wet it expands causing casing 601 to expand, as shown in simplified cross-section view in FIG. 6C. As casing 601 comprises a flexible material casing 601 stretches to accommodate the expansion of the now wet expandable plant-growing medium. Optionally, casing 601 comprises a flexible fluid-permeable material that also has weed-deterring properties, for example, properties similar anti-weed sheets used in traditional gardens.

Alternatively, casing 601 is not pre-filled with a plant-growing medium but is inserted by the user via an opening (not shown), therein. Optionally, casing 601 comprises a fastening device, for example a zipper, that creates an opening when open, for the plant-growing medium can be inserted into casing 601 via the opening in the fastening device. When closed, the fastening device prevents the plant-growing medium from escaping casing 601. Optionally, the fastening device is integrated into casing 601. Alternatively, the fastening device comprises fastening tape. Alternatively, the fastening device comprises fastening tape sold under the trademark Velcro™ consisting of opposing pieces of fabric, one with a dense arrangement of tiny nylon hooks and the other with a dense nylon pile, that interlock when pressed together, used as a closure. Alternatively, another fastening device is used. Optionally, the fastening device is not integrated into casing 601. Optionally, casing 601 comprises a weed-deterring material, for example, a material similar to weed control fabric used in traditional gardens.

Optionally, a casing for retaining a plant-growing medium comprises one or more handles. For example, shown in FIG. 6A are handles 613 and 614, for carrying casing 601. The quantity and locations of handles vary with the shape and size of a casing.

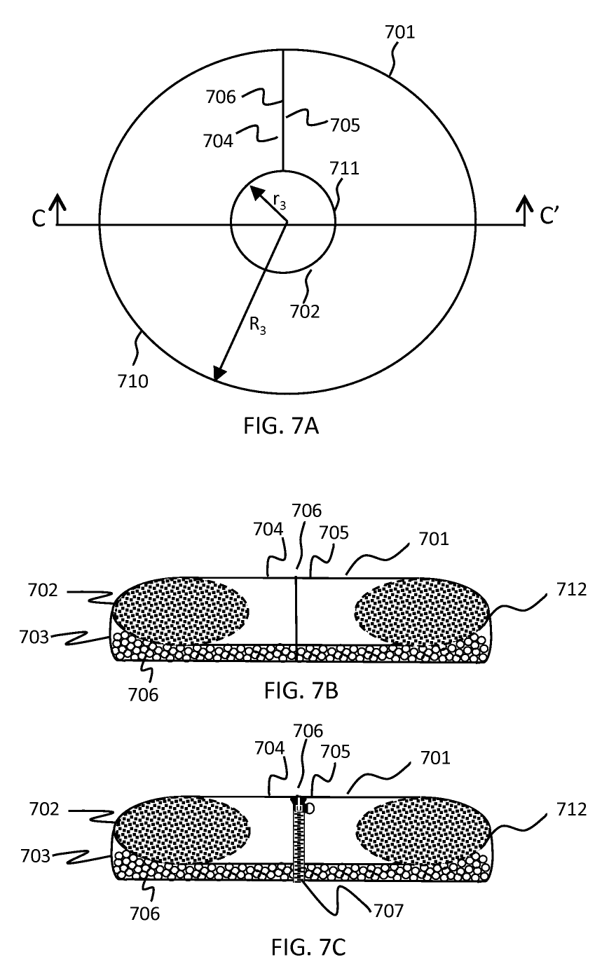

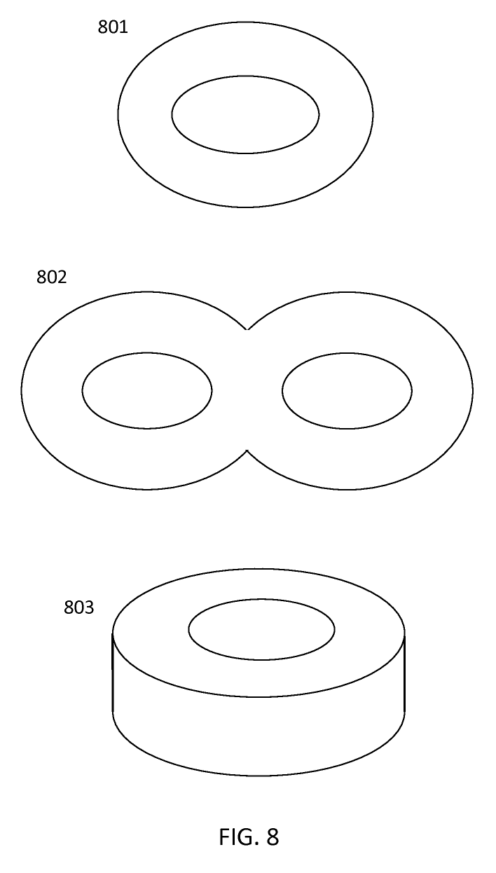

Shown in FIG. 7A is a simplified top view of an embodiment according to the invention. Casing 701 for retaining a plant-growing medium is preformed/manufactured into a toroid-shape. Casing 701 comprises a flexible fluid-permeable material having an inner ring 711 of radius r, r>0 and a larger outside ring 710 of radius R, where R>r. In this example, r=r₃ and R=R₃. Casing 701 is not continuous and comprises two ends, 704 and 705, adjacent one to the other at location 706. A plant-growing medium (not shown), for example, topsoil, is inserted into casing 701 via an opening (not shown), therein. Optionally, casing 701 comprises a fastening device wherein the opening is created when the fastening device, for example a zipper, is open. When closed, the fastening device prevents the plant-growing medium from escaping casing 701. Optionally, the fastening device is integrated into casing 701. Alternatively, the fastening device comprises fastening tape. Alternatively, the fastening device comprises a fastening tape sold under the trademark Velcro™ consisting of opposing pieces of fabric, one with a dense arrangement of tiny nylon hooks and the other with a dense nylon pile, that interlock when pressed together, used as a closure. Alternatively, another fastening device is used. Optionally, the fastening device is not integrated into casing 701. Optionally, casing 701 comprises a weed-deterring material, for example, a material similar to weed control fabric used in traditional gardens.

Now referring to FIG. 7B, shown is a simplified cross-sectional view of casing 701 at C-C′, wherein casing 701 comprises drainage medium 706, such as a drainage medium sold under the trademark Rooflite™. In this specific and non-limiting example, material 703 is attached to a bottom portion 712 of casing 701 as shown in FIG. 7B, and drainage medium, 706, is placed therebetween. Alternatively, material 703 is not attached to bottom portion 712, drainage medium 706 is inserted directly into casing 701 and a plant-growing medium is placed on top thereof. Other specific and non-limiting examples of drainage mediums include gravel, plastic pellets and polystyrene foam balls, for example polystyrene foam balls sold under the trademark Styrofoam™.

Now referring to FIG. 7C, shown is casing 701, comprising a coupling mechanism 707, for example a zipper, for detachably coupling ends 704 and 705 to form a continuous toroid-shape. In this example, coupling mechanism 707 is integrated into casing 701. Alternatively, the coupling mechanism comprises fastening tape. Alternatively, the coupling mechanism comprises a fastening tape sold under the trademark Velcro™ consisting of opposing pieces of fabric, one with a dense arrangement of tiny nylon hooks and the other with a dense nylon pile, that interlock when pressed together, used as a closure. Alternatively, another coupling mechanism is used. Alternatively, the coupling mechanism is not integrated into casing 701. Optionally, casing 701 comprises at least a handle. Optionally, the user purchases casing 701 without a drainage medium. The user inserts a drainage medium into casing 701. Optionally, the user purchases casing 701 without a plant-growing medium. The user inserts a plant-growing medium into casing 701.

Now referring to FIG. 8, shown are simplified specific and non-limiting examples of embodiments of the invention discussed above. For example, a casing has an elliptical toroid shape 801, double torus shape 802 and torus shape 803 with a square cross-section. Other toroid shapes can be envisaged without departing from the scope of the invention.

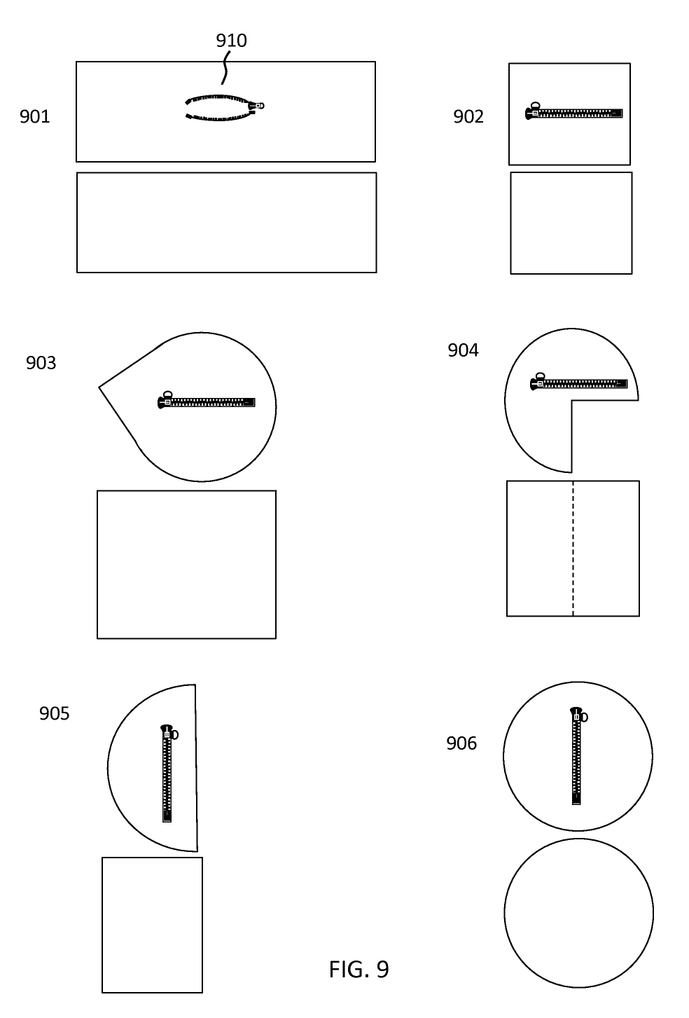

Shown in FIG. 9, is a simplified top and profile view of an exemplary embodiment of an enclosed casing according to the invention. Enclosed casing 901 is for retaining a plant-growing medium comprising flexible fluid-permeable material having an integrated fastening device 910. Fastening device 910 for detachably coupling two portions of an enclosed casing together. When fastening device 910 is open, a plant-growing material can be inserted into enclosed casing 901 via open fastening device 910. A specific and non-limiting example of a fastening device is a zipper. FIG. 9 shows fastening device 910 open. When closed, fastening device 910 prevents the plant-growing medium from escaping enclosed casing 901. Alternatively, the fastening device comprises fastening tape. Alternatively, the fastening device comprises fastening tape sold under the trademark Velcro′ consisting of opposing pieces of fabric, one with a dense arrangement of tiny nylon hooks and the other with a dense nylon pile, that interlock when pressed together, used as a closure. Enclosed casing 901 is rectangular in shape, however, an enclosed casing may be any shape. Some specific and non-limiting examples of enclosed casing shapes are 902, 903, 904, 905 and 906. Optionally, casing 901 comprises a weed-deterring material, for example, a material similar to weed control fabric used in traditional gardens.

Optionally, enclosed casing 901 comprises a drainage medium, such as drainage medium sold under the trademark Rooflite™. The drainage medium is inserted directly into enclosed casing 901 via fastening device 910 when open. Alternatively, the drainage medium is integrated into the enclosed casing 901. Other specific and non-limiting examples of drainage mediums include gravel, plastic pellets, and polystyrene foam balls, for example polystyrene foam balls sold under the trademark Styrofoam™. Optionally, enclosed casing 901 comprises a handle.

A user purchases enclosed casing 901 prefilled with a plant-growing medium. Alternatively, casing 901 is empty and the user fills casing 901 with a plant-growing medium. Optionally, enclosed casing 901 is prefilled with a drainage medium prior to purchase by the user. The user punctures holes in enclosed casing 901 and plants plant material, such as flower bulbs into the plant-growing medium via the punctured holes. Alternatively, the plant material is seed. Alternatively, the plant material comprises plugs. Casing 901 is watered, the water passes through the flexible liquid-permeable material of casing 901. Alternatively, casing 901 is watered prior to puncturing holes. Over time, flowers grow out of casing 901. A rectangle of flowers is esthetically pleasing, and by using an enclosed casing such as casing 901 to create such a landscape, a user avoids much of the traditional work associated with planning and planting a garden. Optionally, plant material such as seeds and/or bulbs are pre-planted in the plant-growing medium prior to the user purchasing casing 901. Optionally, markings on the casing exterior indicate to the user where holes are to be created. Optionally, the casing comprises portions having score lines, making it easier for the user to remove the portions of casing 901 to create holes. Alternatively, a casing is sold comprising plant plugs and the user need only place the casing in a desired location and then water the casing to encourage the existing plants to grow.

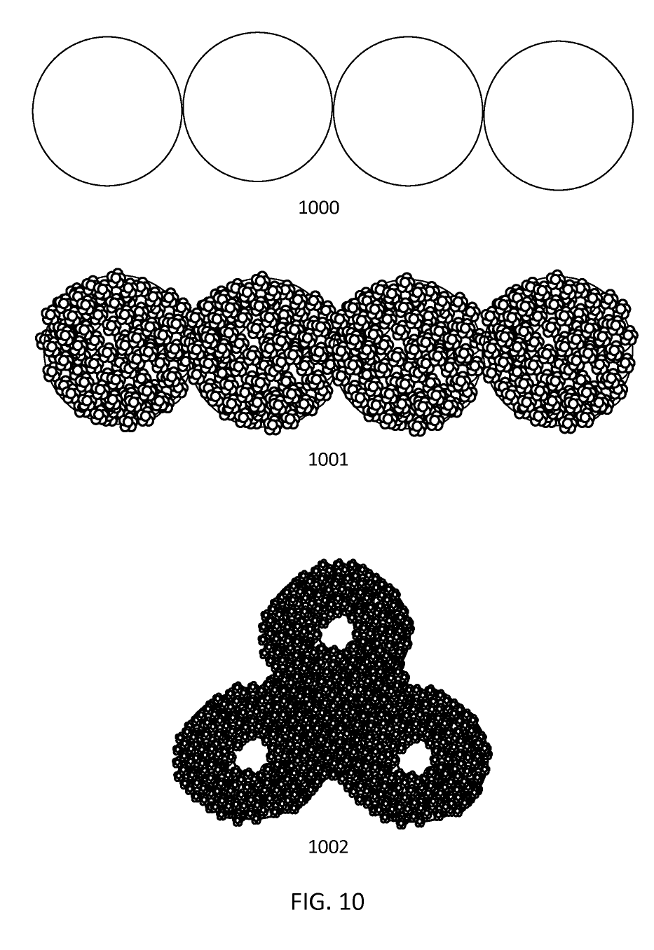

According to an embodiment of the invention, each casing described above comprises an attachment mechanism to detachably couple a casing to one or more other casings. Attaching a plurality of casings together enables a user to configure a garden of different shapes. Should the user wish to rearrange the garden, the user need only detach the casings from each other and re-attach casings where desired. A specific and non-limiting example, of an attachment mechanism comprises fastening tape. Alternatively, the attachment mechanism comprises fastening tape sold under the trademark Velcro′ consisting of opposing pieces of fabric, one with a dense arrangement of tiny nylon hooks and the other with a dense nylon pile, that interlock when pressed together, used as a closure. The attachment mechanism is integrated into the casing. Alternatively, the attachment mechanism does not comprise fastening tape. Alternatively, the attachment mechanism is not integrated into the casing. Shown in FIG. 10 are simplified diagrams of casings detachably coupled. A user fills four ball-shaped enclosed casings 1000 with a plant growing medium, punctures holes in each of the four casings, plants plant material, such as flower bulbs, into the plant-growing medium and linearly couples the four ball-shaped enclosed casings together. When flowers grow out of and cover each of the four enclosed casings the result is an esthetically pleasing garden 1001. By using enclosed casings such as casings 1000 to create a garden, a user avoids much of the traditional work associated with planning and planting a garden. Another garden 1002 is similarly created by detachably coupling three toroid-shaped casings. Optionally, all embodiments comprise a double layer of flexible fluid-permeable material for increased durability.

Alternatively, any of the casings described above can be purchased by a user empty with at least one of a plant-growing medium, plant material and a drainage material external to the casing.

The embodiments presented are exemplary only and persons skilled in the art would appreciate that variations to the embodiments described above may be made without departing from the scope of the invention.

What is claimed is:

1. An apparatus for landscaping comprising:
a first casing of flexible fluid-permeable material of toroid-shape, having an inner radius, r, r>0, and an outer radius, R, R>r, for retaining a plant-growing medium within the first casing.

2. The apparatus according to claim 1 wherein the first casing is non-continuous having a first end and a second end, the second end adjacent the first end.

3. The apparatus according to claim 2 comprising a coupling mechanism for detachably coupling the first end of the first casing to the second end of the first casing.

4. The apparatus according to claim 1 comprising an attachment mechanism for detachably coupling the first casing with a second other casing.

5. The apparatus according to claim 1 wherein the first casing comprises an opening for inserting the plant-growing medium into the first casing.

6. The apparatus according to claim 5 wherein the first casing comprises a fastening device for closing the opening.

7. The apparatus according to claim 1 wherein the first casing comprises a drainage medium for drainage of fluid from the plant-growing medium.

8. The apparatus according to claim 1 wherein the first casing comprises weed-suppressing material for suppression of weeds.

9. The apparatus according to claim 1 wherein the first casing comprises at least a handle for moving the first casing.

10. The apparatus according to claim 1 wherein the first casing comprises at least a portion having score lines for removing the at least a portion.

11. The apparatus according to claim 1 wherein the first casing comprises the plant-growing medium.

12. The apparatus according to claim 1 wherein the first casing comprises plant material.

13. An apparatus for landscaping comprising:
an enclosed first casing of flexible fluid-permeable material having:
an opening for inserting a plant-growing medium into the enclosed first casing; and
a fastening device for closing the opening for retaining the plant-growing medium within the first casing.

14. The apparatus according to claim 13 comprising an attachment mechanism for detachably coupling the first casing with a second other casing.

15. The apparatus according to claim 13 wherein the first casing comprises a drainage medium for drainage of fluid from the plant-growing medium.

16. The apparatus according to claim 13 wherein the first casing comprises weed-suppressing material for suppression of weeds.

17. The apparatus according to claim 13 wherein the first casing comprises at least a handle for moving the first casing.

18. The apparatus according to claim 13 wherein the first casing comprises at least a portion having score lines for removing the at least a portion.

19. The apparatus according to claim 13 wherein the first casing comprises the plant-growing medium.

20. The apparatus according to claim 13 wherein the first casing comprises plant material.

21. A method for landscaping comprising providing a first casing of flexible fluid-permeable material of toroid-shape and inserting a plant-growing medium within the first casing.

22. The method of claim 21 comprising detachably coupling a first end of the first casing with a second end of the first casing with a coupling mechanism.

23. The method of claim 22 comprising detachably coupling the first casing with a second other casing with an attachment mechanism.

24. A kit for landscaping comprising:
a casing of flexible fluid-permeable material of toroid-shape, having an inner radius, r, r>0, and an outer radius, R, R>r, for retaining a plant-growing medium within the casing; and
at least one of the plant-growing medium, a drainage medium for drainage of fluid from the plant-growing medium and plant material.
